(19) United States
(12) Patent Application Publication
(10) Pub. No.: US 2010/0262635 A1
(43) Pub. Date: Oct. 14, 2010

(54) ELECTRONIC APPLIANCE FOR COLLECTING AND DISTRIBUTING DIGITAL MEDIA

(76) Inventor: Richard S. Hambleton, Cambridge, MA (US)

Correspondence Address: BARRY W. CHAPIN, ESQ.;CHAPIN INTELLECTUAL PROPERTY LAW, LLC, WESTBOROUGH OFFICE PARK, 1700 WEST PARK DRIVE, SUITE 280, WESTBOROUGH, MA, 01581, US

(21) Appl. No.: 12/822,972

(22) Filed: Jun. 24, 2010

(30) Foreign Application Priority Data
Dec. 24, 2008 (US) PCT/US2008/088297

(51) Int. Cl. G06F 12/02; G06Q 30/00; G06Q 50/00; G06F 21/24; G06F 17/30

(52) U.S. Cl. 707/812; 705/14.23; 711/162; 726/29; 707/E17.005; 711/E12.002

(57) ABSTRACT

A media archiver that detects receipt of a plurality of first computer readable mediums from different users. Each of the first computer readable mediums includes a set of content items generated by a respective different real-time content capture device that captured each content item of the set in real time by a respective user. Upon receipt of each of the plurality of first computer readable mediums, the media archiver detects a property of a content item(s) in the first computer readable medium that indicates the content item was created during a predetermined time period. The media archiver copies the content item (i.e. the content item created during the predetermined time period) from the first computer readable medium to a second removable computer readable medium to allow a user to collect all content items in one place from all users.

### CROSS REFERENCE TO RELATED APPLICATIONS

This patent application claims priority to International Application PCT/US2008/88297 filed on Dec. 24, 2008, which claims priority to Provisional Application 61/008,798, filed on Dec. 26, 2007, the contents and teachings of which are hereby incorporated by reference in their entirety.

### BACKGROUND

The proliferation of portable electronic digital media recording devices such as digital cameras (both still image and video cameras), wireless phones that include cameras, and the like has created many opportunities for users of such devices to record, capture and distribute digital content such as digital videos and/or digital photograph images. As an example, a user operating a digital camera can easily capture many tens or hundreds of digital photos or videos over a given time period. In most digital media recording devices such as digital cameras, the device stores the captured content (videos or pictures) within a high capacity memory card. After capturing digital content in this manner (e.g. as digital binary data stored within the digital media recording device), the user may desire to transfer this digital content to a computer system for long term storage, for printing or editing purposes, or for redistribution to others (e.g. giving photos to friends, creation of a web site, etc.). There are a number of ways a user can extract the digital content from a digital media recording device such as a digital camera.

As an example, the user may remove the memory card from a digital camera and insert the memory card into a slot on a printer that is equipped with an interface (e.g. a memory card slot) designed to accept such memory cards. The user can then operate the printer (e.g. via a small LCD display provided on the printer) to select specific photos that the printer is to print. When photo selection is complete, the user can cause the printer to begin printing the selected photos. As an alternative to removing the memory card from the camera, the user can electronically couple the camera to a computer system via a cable such as a Universal Serial Bus (USB) cable, or via a wireless or network data communications link. The computer system executes software that the user can control to download or otherwise extract the captured digital images or videos from the camera. The computer system can store the digital content as individual files on a hard disk for long term storage and software on the computer system can allow a user to print, edit, distribute (e.g. email or upload to a website) or otherwise utilize the digital content as he or she desires.

Conventional digital photo kiosks are also publicly available (e.g. in stores) to allow users to transfer their digital photos onto a variety of digital storage media, such as a CD-ROM, or to print such photos on paper. When using such conventional digital photo kiosks, a user inserts the digital storage media, such as the memory card from the user's camera containing the user's digital photos, into the conventional digital photo kiosk. The conventional digital photo kiosk allows the user to select the digital photos he or she wishes to be printed, or to be copied onto a CD-ROM, and the conventional digital photo kiosk prints the selected photos and, if the user chooses, “burns” the selected photos from the user's memory card to the CD-ROM.

### BRIEF DESCRIPTION

Conventional mechanisms for capturing and distributing digital content suffer from a variety of deficiencies. As an example, conventional digital photo kiosks are designed to print or copy to removable media only those photos which have been selected by a user inserting the memory card into the kiosk. Conventional photo kiosks thus ensure that the person who possesses and inserts the memory card gets to determine which photos get printed or “burned” onto the CD-ROM. The kiosk is fully user interactive and requires the user to operate with the system to select, edit and specifically determine all photos that are provided to the kiosk for printing or for placement onto computer readable media (e.g. CD-ROM). Additionally, such kiosks provide no mechanism to distribute photos to others in an efficient manner. Also, such kiosks do not aggregate photos from multiple memory cards inserted from different persons at different times onto a single medium removable from the kiosk that is then shared with a different person than those people who took the photos.

To illustrate how this problem extends to distribution of a user's photos, suppose an event such as a wedding is held and hundreds of people attend. During the event, many different people using many different digital cameras will take pictures and videos of different images and scenes that occur over the course of the event. Conventional techniques to distribute the digital content captured by all attendees of the event to one or more destinations (e.g. to the bride and groom) rely on each individual person to make this distribution possible. This involves each person taking the pictures or videos, bringing the camera home, and coupling their respective digital camera to his or her own computer system, extracting the photos from the camera, and then either emailing, printing, or uploading the digital content to a web site, ftp site or other remotely accessed volume for others to access the content. The problem with this approach is that it depends on the reliability of each individual person to make sure these steps get done. Many people who leave the event may forget to do this, or may simply be too lazy to bother with the time it takes to download the pictures, and then distribute them to others who attended the event. Moreover, people may elect not to provide all photos taken at the event (i.e. at their discretion) and thus candid photos or others may not be provided for review by others. In other words, conventional photo or video content distribution methods rely heavily on the discipline, editing and selection skills of each respective end user as to which photos are deemed to be worthy of distribution. As a result, the collection of all digital media content from the event, as captured on many different and individually owned digital media recording devices, rarely happens.

Techniques discussed herein significantly overcome the deficiencies of conventional digital photo kiosks and content distribution techniques such as those discussed above. In particular, a system, methods and devices described herein provide a media archiver computer system that can be placed in a common location at an event, such as on a table at an exit area of a wedding reception, for access by all attendees of the event. The media archiver is equipped with a user interface and processing capabilities that allow each attendee to provide digital content such as pictures or videos captured at the event into a single repository such as a removable storage device. As an example, each attendee may remove his or her memory card from his or her digital camera and insert the memory card into an interface on the media archiver. Software processing within the media archiver detects the presence of the newly inserted memory card and in response, copies media content items such as digital photo files or video files from the memory card into a storage area. In one configuration, the media archiver processing can be configured to only copy those content items that are created within a predetermined time period, such as those photos and/or videos placed, saved or stored onto the memory card (by the user taking pictures or videos with his or her camera) within the last eight hours (note this time period is used by way of example only and is not meant to be limiting). Once the media archiver collects (i.e. copies from the memory card) the content items matching this property (i.e. those files on the memory card no older than 8 hours), the media archiver can store them in a removable storage device such as a USB storage device, or they may be placed onto a removable CD-ROM. The media archiver can then provide a signal to the user (the person who inserted his or her memory card into the media archiver) that processing is complete, and the user can remove his or her memory card. This processing can be repeated for many different attendees at the event, thus allowing the media archiver to collect digital media content items from a number of different media recording devices operated by different people during the course of the event. In this manner, all photos and videos taken by many different event attendees using many different cameras can be automatically captured in one location. In certain embodiments, little user involvement is required in this process other than inserting their memory cards or otherwise connecting their camera (or other media recording device) to the media archiver computer system. In a fully automated embodiment, the user simply inserts their card, waits for the pictures to be copied, then removes the card when prompted to indicate the copy process is complete.

The media archiver automatically copies these content items onto removable storage and this storage can then be distributed to one or more attendees of the event, such as the bride and groom to allow them to have a complete set of photos and/or videos made by all attendees at the event. The system does not require each person to remember to go home and then download their photos to their computer and then email them or post them on a website for others to access. Additionally, the system can store all captured and copied content into an internal media storage area for later use, such as for creation of photo albums, web sites, and the like, further allowing other users to view content of different event attendees.

More specifically, in various embodiments, a media archiver computer system provides a computer-implemented method that detects connection of a plurality of first removable computer readable mediums (e.g. memory cards of different cameras from different users) to the media archiver computer system. Each of the first removable computer readable mediums stores a set of content items such as digital photos or video or other recordings (audio, visual, etc.) and each set of content items is generated by a respective different real-time content capture device that captured each content item of the set in real time by a respective different user. Upon connection (e.g. insertion of memory card into slot, or coupling of device via cable or wireless uplink) of each of the plurality of first removable computer readable mediums to the media archiver computer system, the system detects at least one property (e.g. an image metric) of at least one content item in the set of content items stored on the first computer readable medium. The property(s) or image metrics include a time property indicating the content item was stored during a predetermined time period within that first removable computer readable medium. As an example, if the content items are photo files, the time property can be a timestamp of when that photo was placed into the camera, relative to the current clock setting of the camera. Other image metrics that can be checked in this manner include attributes of the photo quality, clarity, blurriness, contrast, and the like. If the property indicates the content item is to be copied to a second computer readable medium, the media archiver copies the content item from the first removable computer readable medium to the second computer readable medium. The second computer readable medium may be, for example, a removable storage medium such as a USB device or CD-ROM onto which all pictures or videos from all users are copied, thus forming a collection of all content items captured at the event. Security can be included in certain embodiments to require an authorization token to be present in the second removable storage medium (the media archiver can check for this token prior to copying content items) in order for the media archiver to copy content items to this second removable storage media. In this manner, not anyone can insert any removable storage device into the media archiver to obtain a copy of all event attendee pictures.

Other embodiments disclosed herein include any type of computerized device, computer system, workstation, handheld or laptop computer, personal digital assistant (PDA), palm computer, smart phone, or the like configured with software and/or circuitry (e.g., a processor) to process any or all of the method operations disclosed herein. In other words, any electronic computerized device such as a computer or a data communications device or any type of processor that is programmed or configured to operate as explained herein is considered an embodiment disclosed herein.

Other embodiments disclosed herein include software programs to perform the steps and operations summarized above and disclosed in detail below. One such embodiment comprises a computer program product that has a computer-readable medium (e.g., tangible computer-readable medium) including computer program logic encoded thereon that, when performed in a computerized device having a coupling of a memory and a processor, programs the processor to perform the media archiver operations disclosed herein. Such arrangements are typically provided as software, code and/or other data (e.g., data structures) arranged or encoded on a computer readable medium such as an optical medium (e.g., CD-ROM), floppy or hard disk or other a medium such as firmware or microcode in one or more ROM or RAM or PROM chips or as an Application Specific Integrated Circuit (ASIC). The software or firmware or other such configurations can be installed onto a computerized device to cause the computerized device to perform the techniques explained as embodiments disclosed herein.

It is to be understood that the system disclosed herein may be embodied strictly as a software program, as software and hardware, or as hardware alone. The embodiments disclosed herein, may be employed in software and hardware such as those designed and/or manufactured by Canditto Incorporated of Cambridge, Mass., U.S.A.

Additionally, although each of the different features, techniques, configurations, etc. herein may be discussed in different places of this disclosure, it is intended that each of the concepts can be executed independently of each other or in combination with each other. Accordingly, the present invention can be embodied and viewed in many different ways.

Note also that this Brief Description section herein does not specify every embodiment and/or incrementally novel aspect of the present disclosure or claimed invention. Instead, this Brief Description only provides a preliminary discussion of different embodiments and corresponding points of novelty over conventional techniques. For additional details and/or possible perspectives (permutations) of the invention, the reader is directed to the Detailed Description section and corresponding figures of the present disclosure as further discussed below.

### BRIEF DESCRIPTION OF THE DRAWINGS

The foregoing and other objects, features and advantages of the invention will be apparent from the following more particular description of embodiments of the methods and apparatus for a media archiver, as illustrated in the accompanying drawings and figures in which like reference characters refer to the same parts throughout the different views. The drawings are not necessarily to scale, with emphasis instead being placed upon illustrating the embodiments, principles and concepts of the methods and apparatus in accordance with the invention.

FIG. 1 is an example block diagram illustrating an architecture of a media archiver computer system that operates as a media archiver according to embodiments herein.

FIG. 2 is an example block diagram of a media archiver detecting properties of content items stored in multiple removable computer readable mediums according to embodiments herein.

FIG. 3 is a flowchart of an example of processing steps performed by the media archiver to detect properties of content items stored in multiple removable computer readable mediums according to embodiments herein.

FIG. 4 is a flowchart of an example of processing steps performed by the media archiver to create a displayable directory icon according to embodiments herein.

FIGS. 5-6 are flowcharts of an example of processing steps performed by the media archiver to detect properties of content items stored in a removable computer readable medium that is inserted multiple times according to embodiments herein.

### DETAILED DESCRIPTION

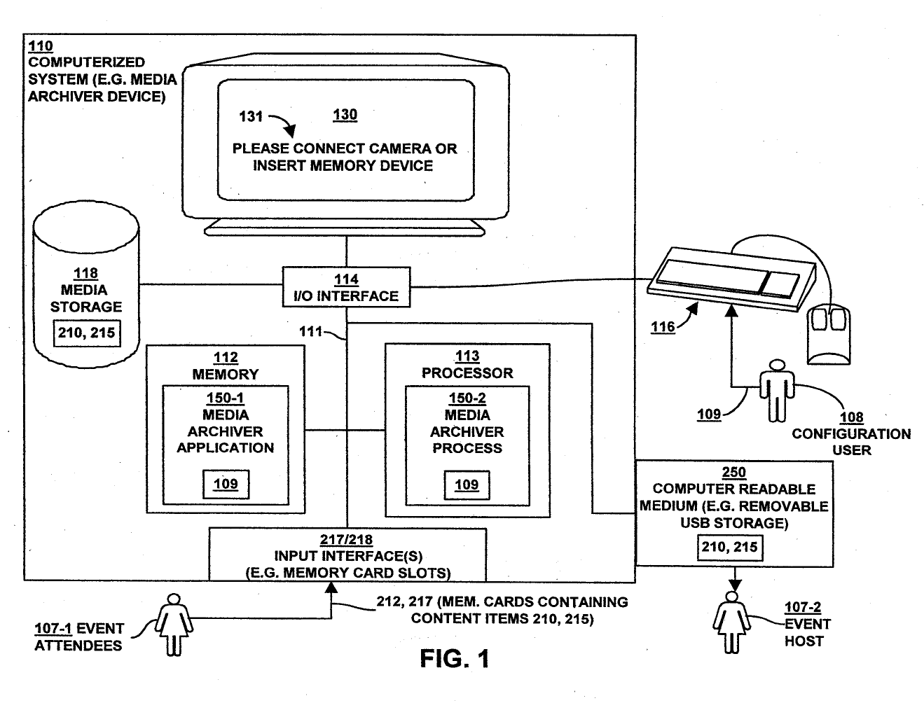

FIG. 1 is an example block diagram illustrating an architecture of a computer system 110 that executes, runs, interprets, operates or otherwise performs a media archiver application 150-1 and/or media archiver process 150-2 (e.g. an executing version of a media archiver 150 as controlled or configured by user(s) 107-1, 107-2 and 108) according to embodiments herein. The computer system 110 may be any type of computerized device such as a personal computer, a client computer system, workstation, portable computing device, console, laptop, network terminal, kiosk, etc. This list is not exhaustive and is provided as an example of different possible embodiments. In one configuration, the computer system is a dedicated portable device (e.g. about the size of a portable radio or laptop computer) that can be easily carried and transported from location to location and can operate on a portable power supply. Users 107-1, 107-2 and 108 interact with the computer system 110 as will be explained. In addition to a single computer embodiment, computer system 110 can include any number of computer systems in a network environment to carry out the processing of embodiments as described herein.

As shown in the present example, the computer system 110 includes an interconnection mechanism 111 such as a data bus, motherboard or other circuitry that couples a memory system 112, a processor 113, an input/output interface 114, input interfaces 218, 219 and a display 130. The display can be simple such as a set of one or more Light Emitting Diodes (LEDs) or may be a computer display capable of render text, images and graphics. In the case of a computer display, the display 130 renders a graphical user interface (GUI) produced by the media archiver 150 (i.e. during execution of the software process 150-2) to users 107 and 108. An input device 116 (e.g., one or more devices such as a keyboard, mouse, touch pad, etc.) couples to the computer system 110 and processor 113 through an input/output (I/O) interface 114. It is to be understood that depending on the complexity of the embodiment, a configuration user 108 may or may not be required.

During operation of the computer system 110, the processor 113 accesses the memory system 112 via the interconnect 111 in order to launch, run, execute, interpret or otherwise perform the logic instructions of the media archiver application 150-1. Execution of the media archiver application 150-1 in this manner produces the media archiver process 150-2. In other words, the media archiver process 150-2 represents one or more portions or runtime instances of the media archiver application 150-1 (or the entire application 150-1) performing or executing within or upon the processor 113 in the computerized device 110 at runtime. The media archiver application 150-1 may be stored on a computer readable medium (such as a floppy disk), hard disk, electronic, magnetic, optical, or other computer readable medium. It is understood that embodiments and techniques discussed herein are well suited for other applications as well. Those skilled in the art will understand that the computer system 110 may include other processes and/or software and hardware components, such as an operating system. Display 130 need not be coupled directly to computer system 110 and as noted above may be a simple arrangement of LEDs to indicate status of operation, or may be a computer display that can render instructions for configuration to the configuration user 108, and for display of instructions during operation while collecting content items to the event attendee users 107. In other configurations, the media archiver application 150-1 can be executed on a remotely accessible computerized device via the communication interface 115.

In one example embodiment, the user 108 is a configuration user such as an owner of renter of the system 110. As a specific example, if the system 110 is used for collections of photos takes by attendee users at weddings, the configuration user may be a Disc Jockey who is hired by the bridge and groom of the wedding to play music. As an added service, the DJ can provide the computer system 110 as an added benefit to his or her service to the bridge and groom. The configuration user 108 (e.g. the DJ) can configures the media archiver 150 with parameters 109 that the media archiver software 150 uses to automatically copy pictures, videos or other media content items from memory cards (or cameras) 212, 217 that event attendee users 107-1 (e.g. guests at the wedding) insert or otherwise couple to input interfaces 218, 219 of the media archiver computer system 110.

The following example will illustrate an exemplary operation of the computer system 110. In a typical operation, the configuration user 108 such as the DJ may provide the media archiver computer system 110 for use at an event such as a wedding. The configuration user 108 may configure the media archiver software 150 with information 109 such as the name of the bride and groom and a welcome message 131 that is to appear on the display 130. Note in another embodiment, the messages that appear on the display are predefined and the configuration user 108 is not required to interact with the computer system 110. The welcome message 131 can instruct event attendee users 107-1 such as guests at the wedding or other event to insert memory devices 212, 217 (i.e., computer readable mediums) or otherwise couple (e.g. via cable or via a communication mechanism such as a wireless data link, text message, email, or other communications transmission technique) digital media recording devices (digital cameras) to the input interfaces 218, 219 in order to share their photos or videos with other event attendees, such as the bride and groom. As an example, the welcome message provided in the configuration settings 109 can be as follows:

“Welcome Mike and Mary's Wedding—if you would like to share pictures you have taken today at the wedding or the reception, please insert your memory card from you digital camera into the appropriate memory card slot in this device before leaving the reception. This device will copy all digital pictures and videos taken by your camera today to a portable storage device to be given to Mike and Mary.”

The configuration user 108 may also provide other information 109 such as a time metric (e.g. 2, 4, 6 or 8 hours) that the media archiver software 150 uses to determine which media files get automatically copied from the memory devices provided by end users 107-1. In such cases, the configuration welcome message can indicate that the device 110 will “ . . . copy all digital pictures and videos taken by your camera in the past X hours to a portable storage device to be given to Mike and Mary” where X is an amount of hours specified by the configuration user 108.

Once configured and then operated on site at the event, end users 107-1 can take pictures or videos during the event with their individual cameras. At any time during the event (e.g. at the end of the event when they are leaving), numerous end users 107-1 can insert or otherwise connect a first computer readable medium (i.e. their camera memory cards) 212, 217 or otherwise couple their cameras to the input interfaces 218, 219 (multiple interfaces 217, 218 are provided for different memory card formats or different types of camera connections, such as USB connectors, memory card slots, and/or wireless communications mechanisms). Upon detection of the inserted or connected first computer readable medium (i.e., memory device or connected camera 212, 217) the media archiver 150 automatically copies, onto a second computer readable medium, such as removable media 250 (and into media storage 118), all files, pictures, videos or other media created (i.e. taken by the users 107-1) within the last X hours, where X is a time parameter that can be configured by the user 108. Note in one configuration, before copying, the media archiver 150 can analyze the content items (e.g. photo image files) on the first computer readable medium 212, 217 to determine if those content items have been copied already. This can be done, for example, by examining and scanning all timestamps and/or image file names of all files in all directories 230, 240 for duplicates prior to copying the content items from a newly inserted memory card. A table of timestamp and filenames may be maintained for this purpose.

In one configuration, the media archiver 150 only copies content items that are not duplicates, and that also match the configuration parameters as explained herein (e.g. those image file stored within the last X hours, and that meet image quality constraints as will be explained). As an example configuration, to avoid situations where a users digital camera clock (i.e. time and date) is not properly set, the media archiver 150 uses relative timestamps of each content item file 210, 215 on the devices 212, 217, beginning with the most recently stored content item, to determine which content items 210, 215 are to be copied. As a specific example, if there are 50 content items 210 (e.g. digital photos and/or images) in a memory card 212 that is inserted, the media archiver 150 analyzes the timestamps of each image file 210 to determine which image file is the most recent. Thereafter, any image files saved into the memory card 212 that are no older than X hours (where X is the configuration parameter that specifies how recent a given image must be in order to it copied from the media 212) relative to the newest image are copied from the first media 212 to the second media 250.

Note in one configuration, the system 110 can include an interface to allow an administrator/configuration user 108 to login remotely (wireless or via physical network connection) to administer or otherwise configure the system 110.

In another configuration, the second computer readable medium 250 can be configured with a token (i.e., an authorization token) that can authorize the copying of content items into the second medium 250, and the token can also identify configuration parameters and/or image metrics such as a number of hours (e.g. a time metric) of time past within which each content item was created (e.g. any pictures no older than 6 hours) in order to be copied to the second medium 250. As an example, if an event has a predetermined know time span (e.g. 3 hours), the second computer readable medium 250 can be preconfigured with a token the indicates only photos taken within the past 3 hours (or any photos no older than 3 hours from the most recent photo) are to be copied from the first medium 212, 217 onto the second medium 250. Additional configuration parameters obtained from the second medium 250 may include messages (e.g. a welcome message to the event) to be displayed to event attendees 107-1 who provide the first mediums 212, 217 from which content items are extracted.

Thus in this example configuration, some or all configuration parameters 109 need not be received via direct input of the configuration user 108, but rather are obtained from insertion of the second removable computer readable medium 250 upon startup of the device (e.g. at the beginning of the event). In such embodiments, the configuration user 108 may be a vendor of the removable second computer readable mediums 250 and these device 250 (e.g. USB thumb drives) may be pre-programmed by the vendor for different purposes (e.g. 2 hours, 4 hours, 8 hour, etc.) and purchased prior to the event by the bride and groom or other event host. In such a configuration then, the system 110 is generic in nature and different operational features and configuration parameters 109 (such as authorization tokens, specified time limits within with content items are to be captured, and the like) are encoded on the storage medium 250 and the device 110 may not be usable or activated until insertion of this second storage device 250.

Also note in one configuration, the second computer readable medium 250 may be remotely located from the computer system 110 and need not be directly coupled to the computer system 110. As an example, the second computer readable medium onto which all content items are copied may be a remote web site or other computer system and the computer system 110 may communicate the content items via any appropriate data communications mechanism (e.g. network, wireless communications, etc.).

Returning to example of the wedding, after attending guests 107-1 have inserted their memory cards and all photos meeting the criteria for copying have been copied to the storage medium 250, the removable storage medium 250 can be retrieved by the user(s) 107-2 such as the bride and groom or other event host. The removable storage media 250 will include a copy of all content items such as digital photos and/or videos taken by each individual event attendee 107. Note that the internal media storage 118 can maintain a secondary copy of all content items provided by end users 107. This secondary copy can be obtained by the configuration user 108 after the event is over for reuse in other ways, such as creation of photo albums, web sites, backup or archival purposes, and the like.

It is to be understood that the mechanism by which user couple their digital cameras to the media archiver computer system can be a physical or non-physical connection. As an example of a non-physical connection, the media archiver in one configuration can utilize communications technologies (wireless or physical) to receive images from each of the users digital media capture devices. As an example, the media archiver can be associated with a phone number, email address, or web address uniform resource locator (URL). Each of these can operate to receive email or text messages or uploading of content that can contain one or more image attachments. In such cases, a user 107 at the event does not need to physically couple his or her camera, phone or other media capture device directly to the input interface 217, 218 of the media archiver system 110. Rather, that user 107-1 can use this communication mechanism as a means for submitting the content items to the media archiver for placement onto the secondary storage device 250. The input interfaces 217, 218 can thus be communication interfaces on a computer network and users 107-1 can submit images, videos or other content items to be archived with other users submissions onto the secondary storage device 250.

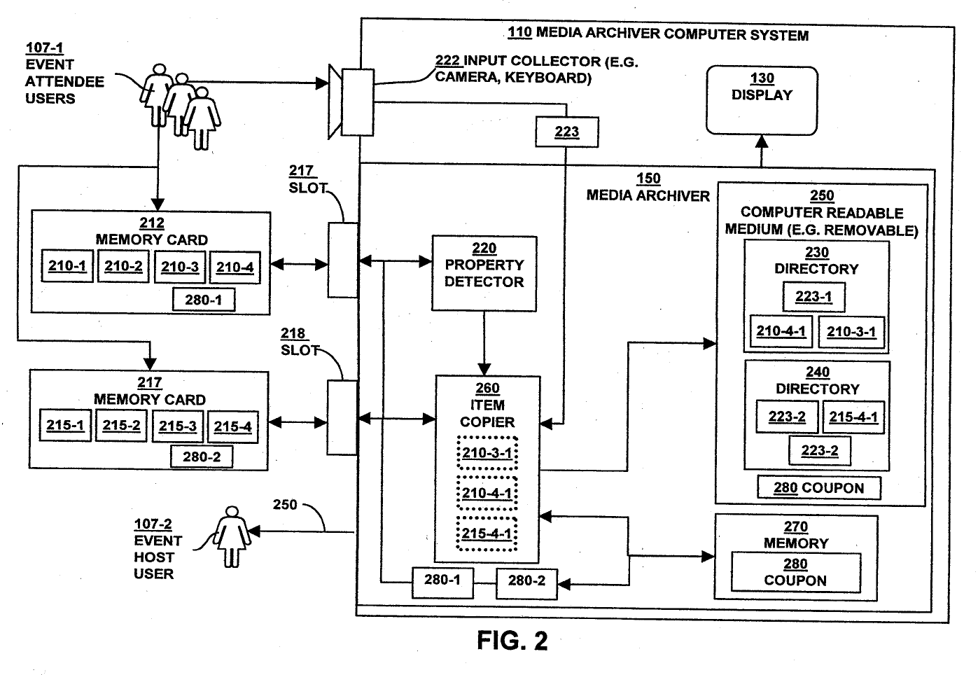

FIG. 2 is an example block diagram showing more details of example embodiments of the media archiver computer system 110 configured with a media archiver 150 according to embodiments disclosed herein. In the example illustrates in FIG. 2, multiple event attendee users 107-1 couple respective computer readable mediums (e.g. memory cards 212, 217) to the media archiver computer system 110.

Example features of this embodiment include an input collector 222 that can be, for example, a digital camera and/or keyboard (not specifically shown) that allows the end users 107-1 such as event attendees to provide attendee user information 223 that the media archiver 150 associates to the media content items 210, 215 that the media archiver 150 copies from the memory devices 212, 217. As an example, when the end users 107-1 insert their memory cards 212, 217, the media archiver 150 can be configured to automatically take a digital picture 223 or receive other input (e.g. a video or audio or text message), via the input collector 222, from the end user 107-1. The media archiver 150 can record this picture, video, audio or text message 223 upon detecting a coupling of the digital media recording device 212, 217, or during the content item copying process, or upon removal of the recording device 212, 217. The media archiver 150 can prompt the event attendee user 107-1 via the display 130 that a picture or other recoding 223 is about to be collected and can provide instructions for the users 107-1 to make this easy for the users 107-1 to understand. In an example configuration, the user 107-1 can interact with a keyboard or other interface to chose whether or not they desire to provide their picture or other data 223 to be associated with the photos or other content items 210, 215 that they are providing to the media archiver 150. The media archiver 150 then associates this picture or video or other data 223 of the end user 107-1 to all files copied from that end user's memory card 212, 217. As an example, for each user 107-1, the media archiver 150 can create a folder (e.g 230, 240, etc.) in the removable storage 250 and in the media storage 118 and can associate or create an icon for that folder to be the digital photo taken of the end user 107-1 captured at the time of connecting the memory card or camera 212, 217 to the media archiver computer system 110. All files copied from the memory devices or cameras provided by that end user 107-1 (for whom a picture or other data 223 has been captured) can be placed in that folder. This processing allows the event host user 107-2 such as the bride and groom to determine who provided a given set of media content items from his or her memory card 212, 217, since all files copied from that card are with the folder for which an icon is the picture taken at the time of collection of these content items. In other configurations, the media archiver 150 can store the video, picture, recording or other information 223 using a special file name (e.g. provider-image.mpg) within the same directory (e.g. 230) that also stores all content items (e.g. 210) provided by a given user 107-1.

It is to be understood that the input collector 222 can be a keyboard, microphone, video camera or other input device that allows a given end user 107-1 the ability to provide his or her identity, as well as a customized and personalized message 223 to be associated to the media content items 210, 215 copied from that given end user's memory card 212 or 217. As an example, the system 110 can take a digital photograph of a user who connects the removable computer readable medium (e.g. the memory card 212, 217) to the media archiver computer system and the system 110 can receive other personalized user input (e.g. a short text message provided via a key board) from the user 107-1. If the user input 223 is a digital photograph, the system can associate a displayable directory icon to the directory 230 created within the removable computer readable medium 250 to allow the directory to be identified as containing content items provided by the user who connected the memory or camera to the media archiver computer system. If personalized user input 223 is received, such as a short video that the input collector 222 takes from the user, the display 130 can prompt the user to leave a short video, audio, or text message and this personalized user input can be stored in the created directory that stored copies of the set of content items copied form the memory card or camera. In a simple configuration, the media archiver 150 simply prompts the user (via a message on the display 130, or via an audible tone, light, or other visual message) that a picture 223 will be taken in a certain amount of time (e.g. in 5 seconds). If the user 107-1 decides to remain in front of the camera 222, the media archiver 150 will take a picture 223 of that user 107-1 automatically, requiring no user involvement.

Other embodiments enable the media archiver computer system 110 to put a new content item 280 onto the memory cards or other mediums 212, 217 for access by each user 107-1 and 107-2. The new content item may be, for example, a copy of a coupon or advertisement 280. In particular, the media archiver 110 can transfer a new content item 280 to the first removable computer readable mediums 212, 217 before or after all content items are copied from those mediums 212, 217. In this manner, the media archiver 150 can upload an image or file such as a copy 280-1, 280-2 of a coupon 280 that provides a discount on a purchase or other transaction related to the set of content items stored within the first removable computer readable medium (e.g. $5 off developing or printing of pictures as a particular photo processing store). The new content item 280 may also contain an advertisement for viewing by a user 107-1 of the first removable computer readable medium (i.e., after removal of the first removable computer readable medium when the user 107-1 bring his or her camera home). In this manner, the media archiver 150 can not only retrieve and copy event photos or video taken by the user 107-1 on behalf of the even host user 107-2, but can also place the new content item 280 into that same user's memory card, as if the media archiver computer system 110 had taken a picture of the coupon or advertisement and placed it onto that user's memory card 212, 217. Note the media archiver 150 can also put a copy of the new content item from the memory card 217 to the second removable computer readable 250 for access by the host user 107-2.

Other embodiments include the ability of the media archiver 110 to authenticate that the second computer readable medium 250 (e.g. a removable USB storage device or CD-ROM) is authenticated to receive the content items according to the processing described herein. As shown in FIG. 2, prior to copying any content item to the second computer readable medium 250, the property detector 220 verifies the second computer readable medium 250 is authorized to receive any content items 210, 215 of the plurality of removable computer readable mediums. To do so, the property detector 220 can verify and confirm the existence or presence of an authorization token 227 that is pre-encoded onto the secondary removable computer readable medium 250. This ensures that only valid computer readable mediums can be inserted into the computer system 110 to receive a copy of the content items from all users 107-1. In one configuration, the non-existence of an authorization token detected within the storage device 250 can make the system 110 inoperative.

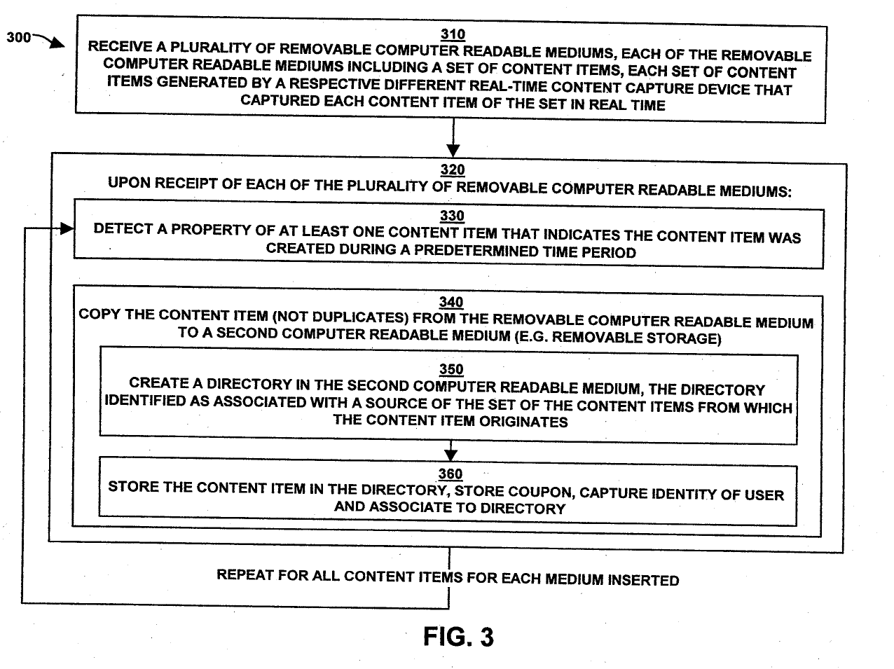

Other aspects of the media archiver 150 illustrated in FIG. 2 will be discussed with respect to the flowcharts presented in FIGS. 3-6. The rectangular elements in flowcharts 300, 400, 500, 600 denote “processing blocks” and represent computer software instructions or groups of instructions upon a computer readable medium. Additionally, the processing blocks represent steps performed by hardware such as a computer, digital signal processor circuit, application specific integrated circuit (ASIC), etc.

Flowcharts 300, 400, 500, 600 do not necessarily depict the syntax of any particular programming language. Rather, flowcharts 300, 400, 500, 600 illustrate the functional information one of ordinary skill in the art requires to fabricate circuits or to generate computer software to perform the processing required in accordance with the present invention.

It will be appreciated by those of ordinary skill in the art that unless otherwise indicated herein, the particular sequence of steps described is illustrative only and may be varied without departing from the spirit of the invention. Thus, unless otherwise stated, the steps described below are unordered, meaning that, when possible, the steps may be performed in any convenient or desirable order.

FIG. 3 is a flowchart 300 of an example of processing steps performed by the media archiver 150 to detect properties of content items stored in multiple removable computer readable mediums according to embodiments herein.

At step 310, the media archiver 150 receives a plurality of first computer readable mediums (such as two or more removable camera memory cards 212, 217). Prior to the coupling of the first removable computer readable mediums 212, 217, the media archiver can prompt the user with a message such as:

“Please remove the memory card from your digital camera and insert the card into an appropriate slot, upon doing so, all image and/or video files no older than 8 hours will be copied onto media to be shared with the event host.”

Each of the first removable computer readable mediums 212, 217 include a respective set of content items 210, 215. For example, a first memory card 212 can include four stored digital photos 210-1, 210-2, 210-3, 210-4 and second memory card 217 can include four stored digital photos 215-1, 215-2, 215-3, 215-4. Each set of content items can be generated by a respective different real-time content capture device that captured each content item 210-1, 210-2, 210-3, 210-4, 215-1, 215-2, 215-3, 215-4 of the set in real time.

In one embodiment, a first user's memory card 212 includes digital photos (or videos) 210-1, 210-2, 210-3, 210-4 generated by a digital camera that is different than the digital camera that generated the digital photos (or videos) 215-1, 215-2, 215-3, 215-4 on the second user's memory card 217. It is understood that the media archiver 150 receives the first memory card 212 as a first user inserts the first memory card 212 into a first slot 219 that is compatible with the first memory card 212. In addition, the media archiver computer system 110 receives the second memory card 217 when a second user inserts the card 217 into a second slot 218 that is compatible with the second memory card 217. It is understood that various embodiments of the media archiver 150 are not limited to providing only two slots for receiving various forms of removable computer readable mediums. Further, the media archiver 150 can perform the steps described herein concurrently on multiple removable computer readable mediums that have been inserted into the digital archiver 150. It is to also be understood that this example processing is not limited to inserting memory cards into slots, and that other couplings of first computer readable media provided by users 107-1 may be provided by the media archiver computer system 110. As an example, the system 110 can provide communications cables or ports for coupling the user's camera, phone, PDA, or other portable media capture device (e.g. one or more USB cables having different end connections) to the system 110. Additionally, the system 110 can provide a wireless communications mechanism that supports data communications protocols such as Bluetooth, 802.11, infrared, or the like to allow the user to provide access to the content items within that user's device.

After a user 107-1 inserts or otherwise couples his or her device or memory card to the system 110, the system can prompt the user that content items from the last “X” hours are about to be copied from that device.

At step 320, upon receipt of each of the plurality of removable computer readable mediums, the media archiver 150 detects a property (or properties) of each content item(s) present in the device. The property(s) indicates the content item was created during a predetermined time period (see step 330). In one embodiment, the media archiver 150 implements a property detector 220 to determine whether any of the content items 210-1, 210-2, 210-3, 210-4, 215-1, 215-2, 215-3, 215-4 stored in the memory cards 212, 217 were created during a particular span of time (i.e. the predetermined time period). In the example illustrated in FIG. 2, the property detector 220 detects that only two images 210-3, 210-4 stored in the first memory card 212 and only one image 215-4 stored in the second memory card 217 were created during the particular span of time.

At step 340, the media archiver 150 copies the content item(s) 210-3, 210-4, 215-4 from the removable computer readable medium(s) 212, 217 to a second computer readable medium 250. During the copy process, the media archiver 150 can display the status of the copy process to allow the user to remain informed about the status of the processing. Note that duplicates content items that have been copied already are not copied, thus is the same user 107-1 inserts the same memory card twice, only content items that are not duplicates will be copied. Duplicate detection can be performed by having the media archiver 150 compare filenames and timestamp information of content items in the memory cards 210, 215 with filenames and timestamp information of content items previously copied from all memory cards (i.e., that are now present within the storage 250, and/or within the internal storage 118). For example, an item copier 260 in the media archiver 150 receives data from the property detector 220 identifying which of the content items 210-1, 210-2, 210-3, 210-4, 215-1, 215-2, 215-3, 215-4 were created during the predetermined time period (or which have timestamps relative to the newest content item that are within the predetermined time period, such as no older than 8 hours relative to the newest content item 210 for memory card 212). The item copier 260 creates copies 210-3-1, 210-4-1, 215-4-1 of the content items 210-3, 210-4, 215-1 identified by the property detector 220.

At step 350, the media archiver 150 creates a directory 230, 240 in the second computer readable medium 250. Each directory 230, 240 is identified as associated with a source of the set of the content items from which the content item originates. For example, the media archiver 150 creates a first directory 230 for content items that (i) are stored on the first memory card 212 and (ii) were created during the predetermined time period. Similarly, the media archiver 150 creates a second directory 240 for content items that (i) are stored on the second memory card 217 and (ii) were created during the predetermined time period. The media archiver 150 associates the first directory 230 with the first memory card 212 and associates the second directory 240 with the second memory card 217. It is understood that the media archiver 150 can associate directories with other attributes as well, such as a photo, text, video or other information 223 obtained from the user 107-1 who inserted the content capture device (e.g. owner of the digital camera) that generated the content items stored in a directory.

At step 360, the media archiver 150 stores the content item(s) (or copies of the content items) 210-3-1, 210-4-1, 215-4-1 in the respective directories 230, 240. Processing also performed in this step includes storing a coupon 280 as an image file within the first computer readable medium, as well as capturing and storing or otherwise associating the identity or other information 223 from the user 107-1 (e.g. a picture of the user) in this same directory 230, 240 (one directory is create for each memory card inserted). For each content item, the media archiver 150 copies the content item copies 210-3-1, 210-4-1 from the first memory card 212 to the first directory 230, and copies a content item copy 215-4-1 from the second memory card 217 to the second directory 240. It is noted that in another embodiment, the media archiver 150 can create multiple instances of each content item copy 210-3-1, 210-4-1, 215-4-1, such that the respective directories 230, 240 can have different resolution versions for each content item copy 210-3-1, 210-4-1, 215-4-1. For example, a directory can have a high resolution version and a low resolution version of a content item copy 215-4-1.

In addition, in another embodiment, upon receiving each of the plurality of removable computer readable mediums (e.g. the memory cards 212, 217), the media archiver 150 transfers a new content item onto the received removable computer readable mediums 212, 217 for storage on the removable computer readable mediums 212, 217. For example, the media archiver 150 creates one or more copies 280-1, 280-2 of a coupon 280 stored in memory 270 and transfers the copies 280-1, 280-2 onto each respective inserted memory card 212, 217. The coupon copies 280-1, 280-2 can be in a printable image format. In another embodiment, as the media archiver 150 transfers the new content item onto an inserted memory card, the media archiver 150 presents a prompt via a graphical user interface, where the prompt communicates a description of the new content item—as well as instructions as to how to use the new content item.

It is noted that the computer readable medium 250 that receives the content item copies 210-3-1, 210-4-1, 215-4-1 can be a portable memory device that is inserted into the media archiver 150 and later removed from the media archiver 150 by an authorized user such as the host user 107-2. In another embodiment, the computer readable medium 250 can be remotely located from the media archiver 150, such as being located within a server system that receives the content item copies 210-3-1, 210-4-1, 215-4-1 according to a wireless transmission protocol. It is understood that the content item copies 210-3-1, 210-4-1, 215-4-1 that are transmitted to the server system can be transmitted in a format such that the content item copies 210-3-1, 210-4-1, 215-4-1 can be rendered on a variety of different media and objects (e.g. photo albums, photo prints, t-shirts, posters, mugs, e-cards, key chains, etc.)

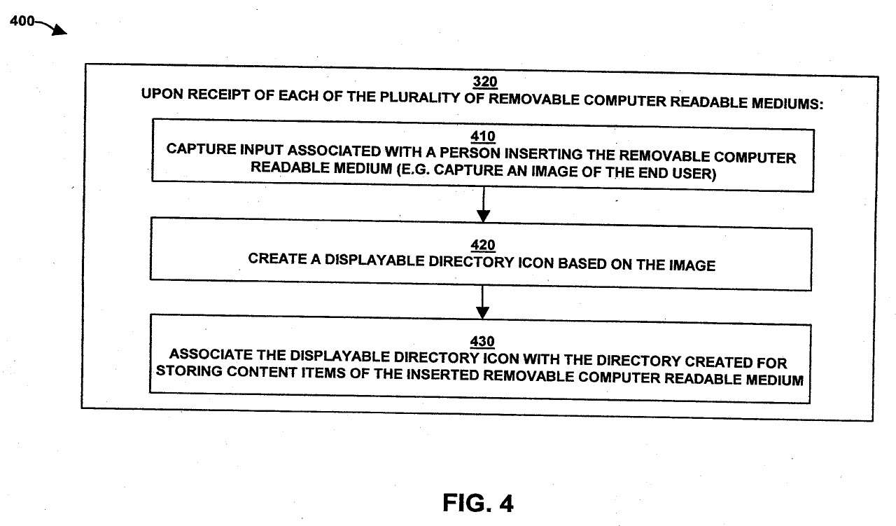

FIG. 4 is a flowchart 400 of an example of processing steps performed by the media archiver to create a displayable directory icon according to embodiments herein. Upon receiving each of the plurality of removable computer readable mediums 212, 217, the media archiver 150 captures an image 223 of a person inserting the removable computer readable medium 212 (or 217) into the media archiver 150 (see step 410). In one embodiment, the media archiver 150 includes a camera focused on an area with respect to one or more slots 218, 219 for receiving removable computer readable mediums 212, 217. For example, as a user 107-1 inserts a memory card 212 into one of the slots 218, 219, the media archiver's 150 camera captures an image 223 of the area upon which it is focused—such as the area surrounding the slot 217. Thus, the media archiver 150 creates an image of the user who is currently inserting the memory card 212 into the slot 217.

At step 420, the media archiver 150 creates a displayable directory icon 223-1 based on the image 223 and, at step 430, associates the displayable directory icon with the directory 230 created for storing content items (e.g. content item copies 210-3-1, 210-4-1) of the inserted removable computer readable medium 212. For example, in one embodiment, the media archiver 150 creates a thumbnail representation of the image of the user inserting the memory card 212 into the slot 217. The media archiver 150 associates the thumbnail with the first directory 230 that stores content items (e.g. content item copies 210-3-1, 210-4-1 that (i) are stored on the first memory card 212 and (ii) were created during the predetermined time period. In an alternative embodiment, rather than modifying a directory icon, the photo 223 that the system 110 takes of the attendee user 107-1 is saved within the directory (e.g. image 223-1 for directory 230, and image 223-2 for directory 240) as an image file. To allow the host user 107-2 who receives the removable storage device 250 to be able to determine which person provided with photos in which directory 230, 240, etc., the photo files 223-1, 223-1, etc. (i.e. one per directory) can be given a special filename to differentiate that photo file from the content item files 210, 215 and the like.

Thus, when an authorized user of the media archiver 150 accesses the computer readable medium 250 that includes the first directory 230 via a graphical user interface, the media archiver 150 presents a representation of first directory 230 incorporating display of the thumbnail. The authorized user is thereby given visual context as to who created the content item copies 210-3-1, 210-4-1 currently stored in the first directory 230 before the authorized user accesses (i.e. opens) the first directory 230.

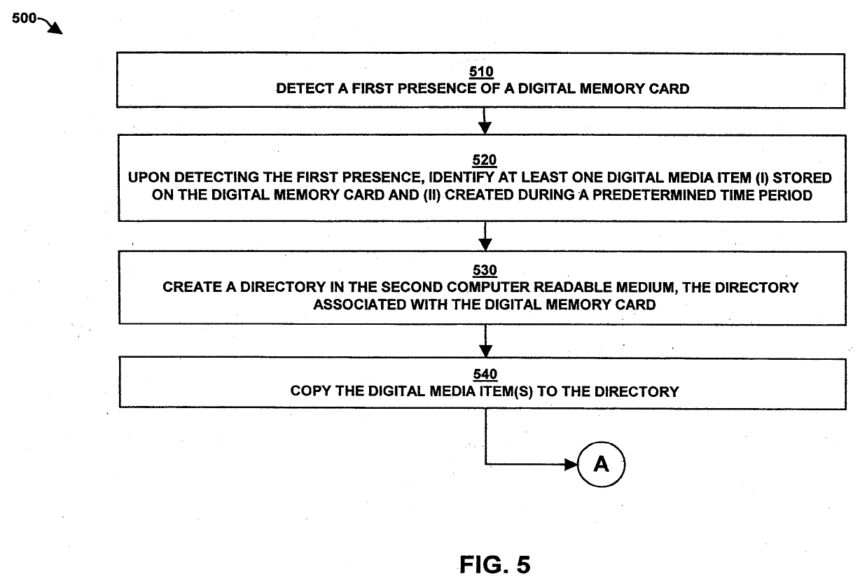

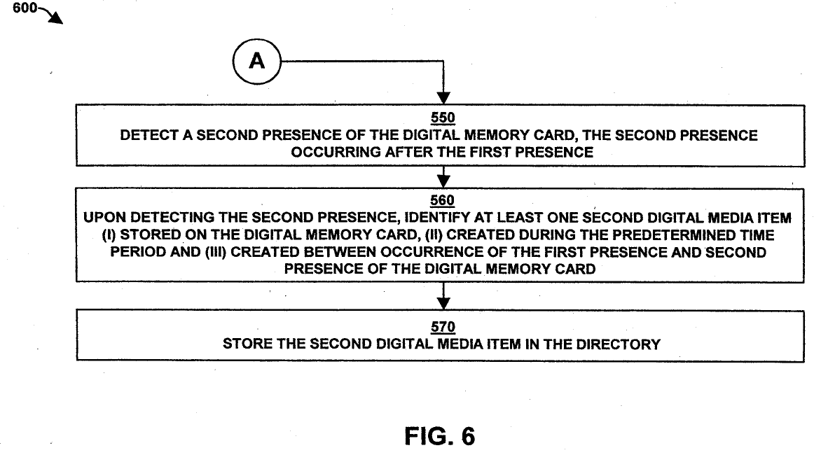

FIGS. 5-6 are flowcharts 500, 600 of an example of processing steps performed by the media archiver 150 to detect properties of content items stored in a removable computer readable medium that is inserted multiple times according to embodiments herein.

At step 510, the media archiver 150 detects a first presence of a digital memory card. For example, the media archiver 150 detects a first time it receives a particular digital memory card 212 at any slot (i.e. card reader orifice) provided by the media archiver 150.

At step 520, upon detecting the first presence, the media archiver 150 identifies at least one digital media item 210-1, 210-2, 210-3, 210-4 (i) stored on the digital memory card 212 and (ii) created during a predetermined time period.

At step 530, the media archiver 150 creates a directory 230 in the second computer readable medium 250 and associates the directory 230 with the digital memory card 212.

At step 540, the media archiver 150 copies the digital media item 210-3, 210-4 to the directory 230. In other words, the media archiver 150 creates copies 210-3-1, 210-4-1 of digital media items 210-3, 210-4 in the digital memory card 212 that were created during the predetermined time period.

At step 550, the media archiver 150 detects a second presence of the digital memory card 212. For example, the media archiver 150 detects an additional (or subsequent) receipt of the digital memory card 212 at any slot (i.e. card reader orifice) provided by the media archiver 150. That is, the user that initially inserted the digital memory card 212 (at step 510) has returned to the media archiver 150 in order to re-insert the digital memory card 212 in the same or different slot 217, 218.

At step 560, upon detecting the second presence, the media archiver 150 identifies at least one second digital media item (i) stored on the digital memory card 212, (ii) created during the predetermined time period and (iii) created between occurrence of the first presence and second presence of the digital memory card 212.

Thus, the media archiver 150 determines that the second presence of the digital memory card 212 represents a re-insertion of the digital memory card 212 into the media archiver 150. To avoid redundant copying of digital media items that were previously copied to the directory 230 upon detecting the first presence of the digital memory card 212, the media archiver 150 identifies digital media items in the digital memory card 212 that were both created during the predetermined time period—as well as created between occurrence of the first presence and second presence of the digital memory card 212.

At step 570, the media archiver 150 stores a copy of a second digital media item (created between occurrence of the first presence and second presence of the digital memory card 212) in the directory 230.

In another embodiment, prior to copying any content item 210-3, 210-4, 215-4 to the computer readable medium 250, the media archiver 150 verifies the computer readable medium 250 is authorized to receive content items in the plurality of removable computer readable mediums 212, 217. For example, the computer readable medium 250 can be a “jump drive” (i.e. a USB Flash drive) that has been inserted into the media archiver 150. For security purposes, the media archiver 150 will not copy content items 210-3, 210-4, 215-4 to any jump drive inserted into the media archiver 150. However, if an inserted jump drive provides the media archiver 150 with correct security data that identifies the jump drive as secure (or authorized) memory device, then the media archiver 150 copies the content items 210-3, 210-4, 215-4 from the multiple memory cards 212, 217 to the jump drive. In one embodiment, the security data can be a code created by a manufacturer of the media archiver 150 that is specific to a user with respect to a particular media archiver 150.

Thus, in order to allow for copying of content items 210-3, 210-4, 215-4 onto the jump drive (or any type of computer readable medium), the media archiver 150 must detect that the jump drive provides a security key that identifies the jump drive as authorized to receive copies 210-3-1, 210-4-1, 215-4-1 of content items 210-3, 210-4, 215-4 from that particular media archiver 150 (or any media archiver 150) for a user identified by the jump drive as being authorized to insert the jump drive. It is understood that in one embodiment, the security key can be encoded into the jump drive and/or can be updated by receipt of additional security data from a website.

In yet another embodiment, when the property detector 220 detects the property of a content item(s) that indicates the content item(s) was created during a predetermined time period (see step 330), the property detector 220 can identify content items for copying based on additional attributes as well. For example, upon identifying a content item (i) present in a received removable computer readable medium (ii) that was created during a predetermined time period, the property detector 220 detects whether that identified content item (e.g. digital image, video, etc.) meets a threshold level of blurriness. If that identified content item meets the threshold level of blurriness, then the media archiver 150 disqualifies the content item from being copied to a directory.

In another embodiment, before creating a copy of content item that was created during a predetermined time period, the media archiver 150 determines whether a content item comprises an image quality property indicating that the content item is a digital photo (or video) that is too dark. If the media archiver 150 determines that the particular digital photo (or video) is too dark, then the media archiver 150 disqualifies that content item (i.e. the dark photo, the dark video) from being copied to a directory.

In yet another embodiment, when a user inserts a digital memory card (or any type of removable computer readable medium) into the media archiver 150, the media archiver 150 prints out a receipt for the user. The receipt can include a code that is compatible with a content repository (e.g. an image management website) and provides access to content item copies created by the media archiver 150. The code allows the user to access the content repository, as well as access that content item copies available via the content repository.

For example, the code may reference the particular event the user attended and thereby allows the user to view (and/or purchase) content item copies of the various content items that were created during the predetermined time period. Thus, the user can use the code to perform an online purchase of digital photos (or other digital media) taken by other people who attended the same event. The code can also include additional data that identifies the particular user with the content item copies received by the media archiver 150 in order to control that user's access to at least a portion of the content item copies related to an event attended by the user. The code can also provide a particular user with a discount price on a variety of transactions that involve content items from the particular event. In another embodiment, the code can be a discount code for any type of transaction.

Note that depending on the embodiment, the media archiver 150 can copy all content items from the first mediums 212, 217 to media storage 118 that serves as a holding area. Additionally, the content items can be transmitted to an offsite storage facility via a network for storage, archival purposes and the like. Thereafter, once all users 107-1 have provided content items as explained above, the user 107-2 can later insert or otherwise connect the second computer readable medium 250 to the media archiver computer system 110 and the copy operations can take place from the media storage 118 to the second removable medium 250. It is at this time that the authorization check can take place using the authorization token 227 to confirm that the second removable computer readable medium is authorized for receipt of the content items from the media storage area 118. In this manner, collection of the content items from users 107-1 does not have to be contemporaneous with placement of those content items 210, 215 onto removable storage 250, since the media storage device 118 may be internal to the media archiver computer system 110 (e.g. an internal hard disk drive).

The methods and systems described herein are not limited to a particular hardware or software configuration, and may find applicability in many computing or processing environments. The methods and systems may be implemented in hardware or software, or a combination of hardware and software. The methods and systems may be implemented in one or more computer programs, where a computer program may be understood to include one or more processor executable instructions. The computer program(s) may execute on one or more programmable processors, and may be stored on one or more storage medium readable by the processor (including volatile and non-volatile memory and/or storage elements), one or more input devices, and/or one or more output devices. The processor thus may access one or more input devices to obtain input data, and may access one or more output devices to communicate output data. The input and/or output devices may include one or more of the following: Random Access Memory (RAM), Redundant Array of Independent Disks (RAID), floppy drive, CD, DVD, magnetic disk, internal hard drive, external hard drive, memory stick, or other storage device capable of being accessed by a processor as provided herein, where such aforementioned examples are not exhaustive, and are for illustration and not limitation.

The computer program(s) may be implemented using one or more high level procedural or object-oriented programming languages to communicate with a computer system; however, the program(s) may be implemented in assembly or machine language, if desired. The language may be compiled or interpreted.

As provided herein, the processor(s) may thus be embedded in one or more devices that may be operated independently or together in a networked environment, where the network may include, for example, a Local Area Network (LAN), wide area network (WAN), and/or may include an intranet and/or the internet and/or another network. The network(s) may be wired or wireless or a combination thereof and may use one or more communications protocols to facilitate communications between the different processors. The processors may be configured for distributed processing and may utilize, in some embodiments, a client-server model as needed. Accordingly, the methods and systems may utilize multiple processors and/or processor devices, and the processor instructions may be divided amongst such single- or multiple-processor/devices.

The device(s) or computer systems that integrate with the processor(s) may include, for example, a personal computer(s), workstation(s) (e.g., Sun, HP), personal digital assistant(s) (PDA(s)), handheld device(s) such as cellular telephone(s), laptop(s), handheld computer(s), or another device(s) capable of being integrated with a processor(s) that may operate as provided herein. Accordingly, the devices provided herein are not exhaustive and are provided for illustration and not limitation.

References to “a processor”, or “the processor,” may be understood to include one or more microprocessors that may communicate in a stand-alone and/or a distributed environment(s), and may thus be configured to communicate via wired or wireless communications with other processors, where such one or more processor may be configured to operate on one or more processor-controlled devices that may be similar or different devices. Use of such “processor” terminology may thus also be understood to include a central processing unit, an arithmetic logic unit, an application-specific integrated circuit (IC), and/or a task engine, with such examples provided for illustration and not limitation.

Furthermore, references to memory, unless otherwise specified, may include one or more processor-readable and accessible memory elements and/or components that may be internal to the processor-controlled device, external to the processor-controlled device, and/or may be accessed via a wired or wireless network using a variety of communications protocols, and unless otherwise specified, may be arranged to include a combination of external and internal memory devices, where such memory may be contiguous and/or partitioned based on the application. Accordingly, references to a database may be understood to include one or more memory associations, where such references may include commercially available database products (e.g., SQL, Informix, Oracle) and also proprietary databases, and may also include other structures for associating memory such as links, queues, graphs, trees, with such structures provided for illustration and not limitation.

References to a network, unless provided otherwise, may include one or more intranets and/or the internet, as well as a virtual network. References herein to microprocessor instructions or microprocessor-executable instructions, in accordance with the above, may be understood to include programmable hardware.

Throughout the entirety of the present disclosure, use of the articles “a” or “an” to modify a noun may be understood to be used for convenience and to include one, or more than one of the modified noun, unless otherwise specifically stated.

Elements, components, modules, and/or parts thereof that are described and/or otherwise portrayed through the figures to communicate with, be associated with, and/or be based on, something else, may be understood to so communicate, be associated with, and or be based on in a direct and/or indirect manner, unless otherwise stipulated herein.

Although the methods and systems have been described relative to a specific embodiment thereof, they are not so limited. Obviously many modifications and variations may become apparent in light of the above teachings. Many additional changes in the details, materials, and arrangement of parts, herein described and illustrated, may be made by those skilled in the art.

What is claimed is:

1. In a media archiver computer system, a computer-implemented method comprising:
detecting connection of a plurality of first computer readable mediums to the media archiver computer system, each of the first computer readable mediums storing a set of content items, each set of content items generated by a respective different real-time content capture device that captured each content item of the set in real time;
upon connection of each of the plurality of first computer readable mediums to the media archiver computer system:
detecting at least one property of at least one content item in the set of content items stored on the first computer readable medium, the at least one property including a time property indicating the content item was stored during a predetermined time period within that first computer readable medium; and
if the at least one property indicates the content item is to be copied to a second computer readable medium, copying the content item from the first computer readable medium to the second computer readable medium.

2. The computer-implemented of claim 1, comprising:
upon connecting each of the plurality of first computer readable mediums, transferring a new content item to the first computer readable medium for storage of the new content item in the first computer readable medium.

3. The computer-implemented as in claim 2, wherein transferring a new content item to the first computer readable comprises:
uploading a file onto the first computer readable medium to be stored within the first computer readable medium, the file including at least one of:
i: a coupon providing a discount on a purchase related to the set of content items stored within the first computer readable medium; and
ii: an message for viewing by a user of the first computer readable medium after removal of the first computer readable medium; and
iii: a link providing access for a user to content items copied to the second computer readable medium

4. The computer-implemented as in claim 1, comprising:
prior to copying any content item to the second computer readable medium, verifying the second computer readable medium as being authorized to receive any content items of the plurality of first computer readable mediums.

5. The computer-implemented as in claim 1, wherein copying the content item from the first computer readable medium to a second computer readable medium comprises:
creating a directory in the second computer readable medium, the directory identified as being associated to the set of the content items to be copied from the first computer readable medium; and
storing the set of content items copied from the first computer readable medium in the directory within the second computer readable medium.

6. The computer-implemented as in claim 5, comprising:
upon connection of each of the plurality of first computer readable mediums:
capturing user input associated with a user who connected the first computer readable medium to the media archiver computer system;
and wherein creating a directory comprises:
associating the user input to the directory created for storing the set of content items within the second computer readable medium.

7. The computer implemented method of claim 6 wherein capturing user input associated with a user who connected the first computer readable medium to the media archiver computer system comprises at least one of:
i: obtaining digital content, including at least one of a digital image, video and audio, of a user who connects the first computer readable medium to the media archiver computer system;
ii: receiving personalized user input from the user who connects the first computer readable medium to the media archiver computer system;
and wherein associating the user input to the directory created for storing the set of content items within the second computer readable medium comprises:
a: if the user input is a digital photograph of a user who connects the first computer readable medium to the media archiver computer system, associating a displayable directory icon to the directory created within the second computer readable medium to allow the directory to be identified as containing content items provided by the user who connects the first computer readable medium to the media archiver computer system; and
b: if personalized user input is received from the user who connects the first computer readable medium to the media archiver computer system, storing the personalized user input in the created directory that stored copies of the set of content items.

8. The computer-implemented method as in claim 1, wherein the content item is a digital image and wherein detecting at least one property of at least one content item in the set of content items stored on the first computer readable medium comprises:
detecting an image metric of the digital image that indicates if the digital image meets a threshold level of acceptance for copying to the second computer readable medium; and
if the image metric indicates that the digital image does not meet the threshold level of acceptance for copying to the second computer readable medium, excluding the content item from being copied to the second computer readable medium;
wherein the image metric includes at least one of an image quality property, a image size property, an image creation date property.

9. The computer-implemented method as in claim 1, wherein copying the content item from the first computer readable medium to the second computer readable medium comprises at least one of:
i: transmitting the content item from the first computer readable medium to the second computer readable medium according to at least one wireless communications mechanism; and
ii: copying the content item from the first computer readable medium to the second computer readable medium which is a portable removable storage medium.

10. The computer implemented method of claim 1, wherein the plurality of removable computer readable mediums includes at least one digital memory card that stores digital media captured by a user media recording device, the method repeating, for each user who connects a first computer readable medium to the media archiver computer system, the steps of:
detecting a presence of the digital memory card connected to the media archiver computer system by a user;
wherein detecting the at least one property includes:
upon detecting the presence of the digital memory card, identifying at least one digital media content item (i) stored on the digital memory card and (ii) created during the predetermined time period;
wherein copying the content item from the first computer readable medium to the second computer readable medium includes:
creating a directory in the second computer readable medium, the directory associated with the digital memory card;
copying the digital media item to the directory;
detecting a second presence of the digital memory card, the second presence occurring after the first presence;
wherein detecting the property includes:
upon detecting the second presence, identifying at least one second digital media item (i) stored on the digital memory card, (ii) created during the predetermined time period and (iii) created between occurrence of the first presence and second presence of the digital memory card; and
wherein copying the content item includes:
storing the second digital media item in the directory.

11. A computer program product including a computer-storage medium having instructions stored thereon providing a media archiver, such that the instructions, when carried out by a processing device, enable the processing device to perform operations of:
detecting connection of a plurality of first computer readable mediums to the media archiver computer system, each of the first computer readable mediums storing a set of content items, each set of content items generated by a respective different real-time content capture device that captured each content item of the set in real time;
upon connection of each of the plurality of first computer readable mediums to the media archiver computer system:
detecting at least one property of at least one content item in the set of content items stored on the first computer readable medium, the at least one property including a time property indicating the content item was stored during a predetermined time period within that first removable computer readable medium; and
if the at least one property indicates the content item is to be copied to a second computer readable medium, copying the content item from the first computer readable medium to the second computer readable medium.

12. The computer program product of claim 11 further comprising instructions to cause the processing device to perform operations of:
upon connecting each of the plurality of first computer readable mediums, transferring a new content item to the first computer readable medium for storage of the new content item in the first computer readable medium.

13. The computer program product of claim 12, wherein instructions for transferring a new content item to the first computer readable comprise instructions causing the processing device to perform operations of:
uploading a file onto the first computer readable medium to be stored within the first computer readable medium, the file including at least one of:
i: a coupon providing a discount on a purchase related to the set of content items stored within the first computer readable medium; and
ii: an message for viewing by a user of the first computer readable medium after removal of the first computer readable medium; and
iii: a link providing access for a user to content items copied to the second computer readable medium

14. The computer program product of claim 11 further comprising instructions to cause the processing device to perform operations of:
prior to copying any content item to the second computer readable medium, verifying the second computer readable medium as being authorized to receive any content items of the plurality of first computer readable mediums.

15. The computer program product of claim 11, wherein instructions for copying the content item from the first computer readable medium to a second computer readable medium include instruction causing the processing device to perform operations of:
creating a directory in the second computer readable medium, the directory identified as being associated to the set of the content items to be copied from the first computer readable medium; and
storing the set of content items copied from the first computer readable medium in the directory within the second computer readable medium.

16. The computer program product of claim 15, comprising instructions causing the processing device to perform operations of:
upon connection of each of the plurality of first computer readable mediums:
capturing user input associated with a user who connected the first computer readable medium to the media archiver computer system;
and wherein creating a directory comprises:
associating the user input to the directory created for storing the set of content items within the second computer readable medium.

17. The computer program product of claim 16, wherein instructions for capturing user input associated with a user who connected the first computer readable medium to the media archiver computer system comprise instructions causing the processing device to perform operations of at least one of:
i: obtaining digital content, including at least one of a digital image, video and audio, of a user who connects the first computer readable medium to the media archiver computer system;
ii: receiving personalized user input from the user who connects the first computer readable medium to the media archiver computer system; and
wherein instructions for associating the user input to the directory created for storing the set of content items within the second computer readable medium comprise instructions causing the processing device to perform operations of:
a: if the user input is a digital photograph of a user who connects the first computer readable medium to the media archiver computer system, associating a displayable directory icon to the directory created within the second computer readable medium to allow the directory to be identified as containing content items provided by the user who connects the first computer readable medium to the media archiver computer system; and
b: if personalized user input is received from the user who connects the first computer readable medium to the media archiver computer system, storing the personalized user input in the created directory that stored copies of the set of content items.

18. The computer program product of claim 17, wherein the content item is a digital image and wherein instructions for detecting at least one property of at least one content item in the set of content items stored on the first computer readable medium comprise instructions causing the processing device to perform operations of:
detecting an image metric of the digital image that indicates if the digital image meets a threshold level of acceptance for copying to the second computer readable medium; and
if the image metric indicates that the digital image does not meet the threshold level of acceptance for copying to the second computer readable medium, excluding the content item from being copied to the second computer readable medium.

19. The computer program product of claim 11, wherein instructions for copying the content item from the first computer readable medium to the second computer readable medium comprise instructions causing the processing device to perform operations including at least one of:
i: transmitting the content item from the first computer readable medium to the second computer readable medium according to at least one wireless communications mechanism; and
ii: copying the content item from the first computer readable medium to the second computer readable medium which is a portable removable storage medium.

20. The computer program product of claim 11, wherein the plurality of removable computer readable mediums includes at least one digital memory card that stores digital media captured by a user media recording device, and wherein instruction including repeating, for each user who connects a first computer readable medium to the media archiver computer system, the operations of:
detecting a presence of the digital memory card connected to the media archiver computer system by a user;
wherein detecting the at least one property includes:
upon detecting the presence of the digital memory card, identifying at least one digital media content item (i) stored on the digital memory card and (ii) created during the predetermined time period;
wherein copying the content item from the first computer readable medium to the second computer readable medium includes:
creating a directory in the second computer readable medium, the directory associated with the digital memory card;
copying the digital media item to the directory;
detecting a second presence of the digital memory card, the second presence occurring after the first presence;
wherein detecting the property includes:
upon detecting the second presence, identifying at least one second digital media item (i) stored on the digital memory card, (ii) created during the predetermined time period and (iii) created between occurrence of the first presence and second presence of the digital memory card; and
wherein copying the content item includes:
storing the second digital media item in the directory.

21. A computer system comprising:
a processor;
a memory unit that stores instructions associated with a media archiver application executed by the processor; and
an interconnect coupling the processor and the memory unit, enabling the computer system to execute the media archiver application and perform operations of:
detecting connection of a plurality of first computer readable mediums to the media archiver computer system, each of the first computer readable mediums storing a set of content items, each set of content items generated by a respective different real-time content capture device that captured each content item of the set in real time;
upon connection of each of the plurality of first computer readable mediums to the media archiver computer system:
detecting at least one property of at least one content item in the set of content items stored on the first computer readable medium, the at least one property including a time property indicating the content item was stored during a predetermined time period within that first removable computer readable medium; and
if the at least one property indicates the content item is to be copied to a second computer readable medium, copying the content item from the first computer readable medium to the second computer readable medium.

22. The computer system of claim 21, wherein the plurality of first computer readable mediums includes at least one digital memory card, the operations further include operations for:
detecting a first presence of the digital memory card;
wherein detecting the property includes:
upon detecting the first presence, identifying at least one digital media item (i) stored on the digital memory card and (ii) created during the predetermined time period;
wherein copying the content item includes:
creating a directory in the second computer readable medium, the directory associated with the digital memory card;
copying the digital media item to the directory;
detecting a second presence of the digital memory card, the second presence occurring after the first presence;
wherein detecting the property includes:
upon detecting the second presence, identifying at least one second digital media item (i) stored on the digital memory card, (ii) created during the predetermined time period and (iii) created between occurrence of the first presence and second presence of the digital memory card; and
wherein copying the content item includes:
storing the second digital media item in the directory.

23. A media archiver computer system comprising:
a plurality of input interfaces, each having a physical configuration adapted to couple to a specific type of storage device used by a digital camera to store digital media content items captured by the digital camera;
an output interface adapted to allow a removable secondary storage device to be coupled and decoupled to the output interface;
a processor;
a memory unit that stores instructions associated with a media archiver application; and
an interconnect coupling the processor, the memory unit, the output interface and the plurality of input interfaces;
the processor executing the instructions associated with the media archiver application to provide a media archiver computer system that performs operations of:
automatically detecting coupling of individual ones of the plurality of storage devices used by digital cameras to respective ones of the plurality of input interfaces, each storage device containing a set of content items containing digital media created and stored in the storage device by a respective user operating his or her digital camera; and
for each storage device coupled to one of plurality of input interfaces, copying at least one content item to the removable secondary storage device.

24. The media archiver computer system of claim 23, wherein recently created content items being those content items that have a time property indicating the digital camera created that content item within a predetermined time period relative to other content items in the storage device, and wherein the removable secondary storage device contains a copy of all recently created content items from each individual ones of the plurality of storage devices used by digital cameras by respective users who coupled their storage devices to one of the plurality of input interfaces.
